(19) United States
(12) Patent Application Publication
(10) Pub. No.: US 2008/0009222 A1
(43) Pub. Date: Jan. 10, 2008

(54) Game caller

(76) Inventor: James S. Lombardi, Fenton, MI (US)

Correspondence Address: The Weintraub Group, P.L.C.;Suite 240, 32000 Northwestern Highway, Farmington Hills, MI, 48334, US

(21) Appl. No.: 11/820,778

(22) Filed: Jun. 20, 2007

Related U.S. Application Data
(60) Provisional application No. 60/815,002, filed on Jun. 20, 2006.

(51) Int. Cl. A01M 31/00

(52) U.S. Cl. 446/207

(57) ABSTRACT

A game caller wherein a reed assembly thereof may be replaced or interchanged and marketed in customized kits provided with elements for repairing or customizing the game caller, and a horn piece thereof is comprised of a pliable material that is pinched, or squeezed, or manipulated, or otherwise deformed by the hunter into a closed relation, at least in part, to change the volume of air through the horn piece and sound pipe whereby to imitate distress sounds during a hunting situation wherein game is coaxed and/or attracted.

### CROSS-REFERENCE TO RELATED APPLICATION

This Application claims the benefit of U. S. Provisional Application Ser. No. 60/815,002, filed on Jun. 20, 2006, the contents of which are incorporated herein by reference in its entirety for all that is taught and disclosed therein.

### BACKGROUND OF THE INVENTION

1. Field of the Invention

This invention relates to a hand call device sounded by blowing through the device for calling both fowl and game animals, and more particularly, to a predator game caller provided with a specially configured tubular bell-shaped horn piece comprised of a pliable material which the user squeezes, pinches or otherwise manipulates to change the shape of the horn piece, whereby to control the volume and flow of air through the horn piece and to imitate the distress sound of a captured animal or fowl.

2. Related Art

Numerous apparatus has been proposed for use by a hunter in calling animals, such as deer, or fowl, such as ducks, turkeys and geese, or predators. As used herein, the use of the term game call and game caller is broadly intended to refer to apparatus for calling fowl as wells as animals.

The sound from a game call device is produced by airflow resulting from placing the lips on a blow tube and blowing air through and across a reed structure in the call device. A desirable game call is easy to use and enables hunters to generate a sound to attract a particular target as well as imitate the sound of a wounded animal and attract predators. The game call may be used by both experienced and inexperienced users to generate a variety of game sounds.

Typically, a predator will respond to the distress signal of small prey animals, ranging in size from a small rodent to the larger jackrabbit and snowshoe hare. Desirably, then, a game call will create loud and erratic distress sounds of a small prey animal. Further, and depending on the predator or target animal, such as a fox, coyote, bobcat, lion, lion, bear or wolf, to name a few, a desirable game call will allow the hunter to alter the tone, pitch and resonance of sound generated by the game call, while simultaneously controlling the volume.

Game call devices have been proposed wherein internal components of the device are manipulated by the user whereby to generate different sounds. Illustrative are the game call devices proposed in U.S. Pat. Nos. 5,613,891, 5,557,946, and 4,940,451.

A game call device proposed by Wiley, U.S. Pat. No. 6,095,884, secures a reed holder centrally of a flexible tube, either one-piece or assembled from a pair of tube sections, and the opposite end portions of the tube structure externally manipulated to generate different sounds. The entire housing is of flexible material.

However, acoustics is not an exact science and the resulting sound generated by air movement in different but similar structures is not predictable. A game caller typically includes a tubular shaped housing having an air passage that extends between opposite ends thereof and opens to the outside and a reed assembly mounted in the air passage. Depending on the structure and mounting arrangement, various resonator chambers and air passages are formed between the opposite ends of the housing. “Blowing air” into the game caller may produce different tones because of the air resonating. Further, the pitch of the tone is related to the resonant frequency of the volume of air caused to resonate. Because of this, the sound from each of two similar game call structures can be unexpectedly different with the sound from one caller imitating the sound needed to attract game and the other not imitating the requisite sound.

Additionally, in general, the reed assembly of a game call that mimics a desired call is generally comprised of a soundboard, a wedge, and a reed. Typically, hand callers are either “closed reed” or “open reed”. An experienced hunter may need to replace a defective reed, modify one or more of these elements, or completely replace a reed assembly in the field with a “customized” call device, depending on whether coaxing game or fowl or luring predators. In a “closed reed” design, special tools are needed to remove or replace a defective reed, resulting in the need for the hunter to carry a toolbox around, or the hunter just discards the game caller. Desirably, the game call would be adaptable for repair or to mount a “customized” reed assembly.

Prior game calling apparatus is believed suitable for some, but not all users, to some degree depending on the experience of the user. Accordingly, there is an ongoing need for improvements in game callers.

### SUMMARY OF THE INVENTION

Accordingly, a principal object of this invention is to provide a game caller of novel construction and configuration to produce an effective calling sound for a variety of animals.

Another object of this invention is the provision game caller having a portion thereof that deforms and changes in shape and volume while being acted upon by an external force wherein to change the acoustics of the game caller.

Another object of this invention is to provide a game caller having a novel tubular bell-shaped horn piece attached to the outlet end of a rigid sound tube, the horn piece being comprised of a deformable material, thin walled, and having a shape and opening that the user can easily manipulate, squeeze, and close, at least in part, whereby to create a call to coax an animal or simulate the distress sound of a prey animal to attract a predator.

Another object of this invention is provision of a game caller having a pliable horn piece integrally molded to the outlet end of the sound pipe, with portions of the mold material, if desired, providing gripping ribs that extend between the ends of the sound pipe.

Another object of this invention is the provision of a game caller that is amenable to sale in kit form, the kit being provided with at least one reed assembly to simulate the call of a respective of several game animals and/or fowl desired to be hunted, the three tubular sections of the game call, which assemble to receive a reed assembly provided with the kit, and components of a reed assembly to enable repair or customizing of the reed assembly by the hunter in the field.

A further object of this invention is to provide a game caller having a rigid blow tube or sound pipe having inlet and outlet ends, a rigid mouth piece at the inlet end for blowing air into the sound pipe, a horn piece of pliable material at the outlet end, and a reed assembly disposed between the ends of the sound pipe, the assembly including a reed that vibrates when acted upon by air blown thereacross, wherein manipulation or squeezing deformation of the horn piece causes the shape and volume thereof to change and the sound produced thereby to be altered in tone, pitch, resonance, and volume.

Still another object of this invention is to provide a game caller to produce and simulate the call of ordinary and distress sounds of game and fowl.

Still another object of this invention is to provide a game caller to produce and simulate the call of ducks, geese, turkeys, owls, mallards and like fowl.

Still another object of this invention is to provide a game caller to produce and simulate the call of game animals, prey and predators, such as deer, wolves, coyotes, lions, bears, bobcats and like animals.

A still further object of this invention is to provide such a game caller of simple construction for ease of assembly, modification, and minor adjustment.

A still further object of this invention is the provision of a game caller including a pliable horn piece, a rigid mouth piece, a sound pipe, and a reed assembly, each assembled together into an operable unit, and a closure cap tethered to the game caller for removable protective fitment about the mouth piece.

These objects are accomplished in the present invention by a game caller wherein a reed assembly thereof may be replaced or interchanged and marketed in customized kits provided with elements for repairing or customizing the game caller, and a horn piece thereof is comprised of a pliable material that is pinched, or squeezed, or manipulated, or otherwise deformed by the hunter into a closed relation, at least in part, to change the volume of air through the horn piece and sound pipe whereby to imitate distress sounds during a hunting situation wherein game is coaxed and/or attracted.

According to this invention, a game caller comprises:

an assembly of three hollow tubular sections, said sections when assembled providing an air passage chamber extending between an inlet end and an outlet end of the assembly, said sections comprising a central sound pipe of rigid material and having first and second ends, a mouthpiece of rigid material, said mouthpiece including a first connectible end and said inlet end, and a horn piece of resiliently deformable material, said horn piece including a second connectible end and said outlet end,

a reed assembly mounted in the sound pipe, said reed assembly having opposite ends disposed longitudinally and an air passage extending between the opposite ends thereof for communicating air between said first and second ends,

first means for connecting said first connectible end of said mouthpiece to the first end of said sound pipe, and

second means for connecting said second connectible end of said horn piece to the second end of said sound pipe,

said horn piece being adapted to change the volume, tone, pitch, and frequency of the sound of air passing through the longitudinal bore thereof and reed assembly therein by substantially simultaneously squeezing, pinching, or otherwise constricting the material thereof to close the outlet end, at least in part, and manipulating and bending and changing the shape, cross-section, and volume of the horn piece.

According to this embodiment, the game caller comprises third means for non-rotatably and removably positioning the reed assembly in the sound pipe.

Of critical significance to this preferred embodiment, the horn piece is comprised of a pliable elastomeric material having the properties of dimensional consistency and capable of bending, flexing, and twisting when squeezed or manipulated to change air flow through the mouthpiece.

While many shapes are possible, depending on the application or game sound to be replicated, according to this embodiment, the horn piece is generally frusto-conical in shape, with the diameter of second connectible end being smaller than the diameter of the outlet end.

In one application, the horn piece is comprised of a thin-walled thermoplastic elastomer.

According to this preferred embodiment, the three sections are generally centered on a common longitudinal axis, and the second connectible end and outlet end, forming the opposite ends of the horn piece, are generally circular and have their centers located on the longitudinal axis.

According to this preferred embodiment, the reed assembly includes a body portion having an outer periphery and a soundboard extending from said body portion, and a flexible reed cantilevered to the body portion and disposed atop the soundboard. The sound pipe includes a cylindrical interior wall and a transverse end wall. The interior wall extends between the transverse end wall and the first end of the sound pipe wherein to define an enlarged chamber for receiving the body portion of the reed assembly. Further, the transverse end wall defines a stop to limit inward insertion and position the reed assembly in the sound pipe.

Preferably, the body portion of the reed assembly is dimensioned to be snugly sandwiched between the mouthpiece and the transverse end wall upon connection of the mouthpiece to the sound pipe.

The third means for non-rotatably and removably positioning the body portion of the reed assembly in the chamber formed in said sound pipe comprises a key and keyway operating between the interior wall of the sound pipe and the outer periphery of the body portion. The key is received in the keyway to angularly orient and prevent rotation of the body portion relative to the sound pipe.

Depending on the application, the game caller includes a pair of keys and respective keyways, the keys extending axially and radially outwardly from the outer periphery of the body portion, and the keyways extending axially and radially inwardly into the interior wall of the chamber. If a proper reed assembly is selected, the keys and keyways will align and interfit with one another and the reed assembly accepted, and if not, the reed assembly will not be accepted.

The first means for connecting the first connectible end of the mouthpiece to the first end of the sound pipe comprises a compression fit between the interior wall of the sound pipe and the first connectible end of the mouthpiece.

Alternatively, other means, such as a threaded interconnection may be used.

The second means for connecting the second connectible end of the horn piece to the second end of the sound pipe is by unitarily forming the horn piece to the second end of the sound pipe, such as by injection molding or the like. In addition to making the horn piece integral with the sound pipe, during molding of the horn piece, several angularly spaced longitudinally extending gripping ribs are formed, each extending from the horn piece to the inlet end of the sound pipe.

In another preferred embodiment according to this invention, there is provided a game caller kit for use by hunters, said kit comprising:

a portable container, said container having a plurality of separated pockets for temporarily storing and transporting items of interest until needed, and

a plurality of transportable items of interest, comprising:

at least one reed body, said reed body including a body portion and a sound board,

a pair of reeds, each reed being mountable in cantilever fashion to said body portion wherein to form a reed assembly, and

a game caller housing, said housing comprising a tubular sound pipe having first and second ends and a chamber for receiving said reed body, a bell shaped horn piece of pliable elastomeric material connected to one of said ends, and a mouth piece, the mouth piece being removably connectible to the other of said ends of the sound pipe wherein to captivate the reed body in the chamber of said sound pipe.

In some applications, the kit may include a pair of reed bodies, each reed body including a body portion and a soundboard, and a pair of reeds, each reed being mountable in cantilever fashion to a selected body portion and form a reed assembly.

According to the game caller kit, respective of the reeds, reed bodies, reed assemblies, and game caller housing are transported in separate pockets.

According to yet another preferred embodiment according to this invention, there is provided a gamer caller of the type including a cylindrical sound pipe having inlet and outlet ends, a mouth piece removably connected to the inlet end, and a reed assembly sandwiched between the sound pipe and the mouth piece, wherein

an interior chamber extends inwardly from the inlet end of said sound pipe, said chamber being formed by an interior wall and a transverse stop,

said reed assembly includes a body portion having opposite end faces and an outer surface, the body portion being insertable into the interior chamber with inward insertion being limited by the stop wall engaging one end face of the body portion, and closing connection of the tail piece to the inlet end engaging the other end face of the body portion and snugly retaining the reed assembly in the chamber, and

a key and keyway operating between the outer periphery of the reed assembly and the interior wall of the chamber, said key and keyway having predetermined widths wherein to permit entry of only a specific reed assembly into the chamber as well as to prevent relative rotation between the reed assembly and the sound pipe.

In the above game caller, the reeds are flat, generally planar, and of uniform thickness. The material may be of metal or polymeric material, depending on the application and vibration.

The novel features and the advantages of the invention, as well as additional objects thereof, will be understood more fully from the following description when read in connection with the accompanying drawings.

### BRIEF DESCRIPTION OF THE DRAWINGS

FIG. 1 is an exploded assembly view, in perspective, of a game caller according to the invention, including, in sequence, a horn piece, a sound pipe, a reed assembly, and a mouthpiece;

FIG. 2 is an end view of the game caller, during assembly, showing the reed assembly disposed in a chamber provided at one end of the sound pipe;

FIG. 3 is a longitudinal sectional view of the game caller of FIG. 1 after being assembled;

FIGS. 4A-4C are perspective views of different reed assemblies with FIG. 4C illustrating repair or assembly of a reed and wedge to a soundboard; and

FIG. 5 is a perspective view of the game caller and a closure cap for protectively snap-fitting about the mouthpiece.

### DESCRIPTION OF THE PREFERRED EMBODIMENT

The drawings illustrate a preferred form of caller according to the invention, generally indicated by the number 10, used by a hunter to produce and simulate the call of ordinary and distress sounds of game and fowl. As will be understood, the caller is hand held and used by a hunter to produce a sound to simulate the call of ducks, geese, turkeys, owls, mallards and like fowl, or game animals, such as deer, or prey and predators, such as wolves, coyotes, lions, bears, bobcats and like animals. In the discussion to follow, the term game caller refers to animals and fowl, and predators or prey, unless indicated otherwise.

The game caller 10 comprises an assembly of three hollow tubular sections 12, 14, and 16, and a reed assembly 18, each tubular section including, respectively, a longitudinal through bore or passage 20, 22, and 24. As will be described below, an air passage 77 extends through the reed assembly 18. The tube sections 12, 14 and 16, when assembled, define inlet and outlet ends 26 and 28. Further, the respective passages 20, 22, and 24 and the air passage 78 combine to define a continuous airway that extends between the opposite ends 26 and 28 of the game caller 10.

The sections 12, 14, and 16 define a central sound pipe or blowing barrel 12 of rigid material and having opposite end faces 30 and 32, a mouthpiece 14 of rigid material and having opposite end faces 34 and 36, and a horn piece 16 of resiliently deformable material and having opposite end faces 38 and 40. The sound pipe 12 is generally cylindrical and includes exterior and interior walls 42 and 44, an interior end wall 46 provided with a central opening 48, and a seating chamber 50 extending inwardly from and between the seating end 32 and interior end wall 46, the chamber 50 being configured and sized to connect to the mouthpiece 14.

The sound pipe 12 may be fabricated from wood, such as cedar wood for example, or from metal or a plastic material.

The mouthpiece 14 is generally cylindrically shaped and includes first and second end portions 54 and 56 and exterior and interior surfaces 58 and 60. The first end portion 54 terminates in the end face 34 and is adapted to be coaxially inserted into the chamber 50. The second end portion 56 is terminates in the end face 36 and is adapted to be engaged by the lips of the user to blow air into the game caller.

The mouthpiece 14 may also be fabricated of wood, such as oak for example, or from metal or a plastic material.

The horn piece 16 is somewhat frusto-conical and forms a bell shape with the opposite ends 38 and 40 thereof being generally circular, the end 38 being connectible to the end face 30 of the sound pipe 12.

Preferably, and according to this invention, the horn piece 16 is connected to the horn piece 16 by directly injection molding a tubular section directly onto the forward end 30 of the sound pipe 12, whereby the two sections 12 and 16 form a one piece unit.

Additionally, during the molding of the horn piece, several thin strips or gripping ribs 52 are also formed, the strips being equiangularly spaced about the wall 44 and extending longitudinally between the opposite ends 30 and 32 of the sound pipe. The injection molded strips 52 are secured to the exterior wall 44 by heat, sonic welding and the like. The strips 52 enable easier gripping of the sound pipe 12 for assembly and/or disassembly and for aesthetical appearance.

Referring to the drawings, FIG. 5 illustrates the game caller 10 wherein the horn piece 16 and strips 52 are molded directly to the sound pipe 12.

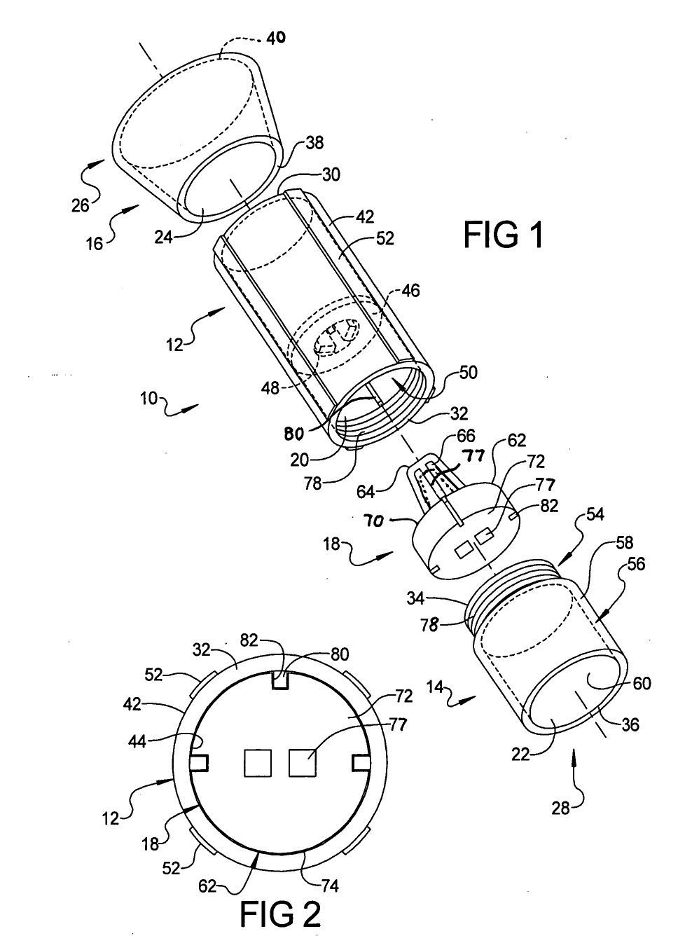

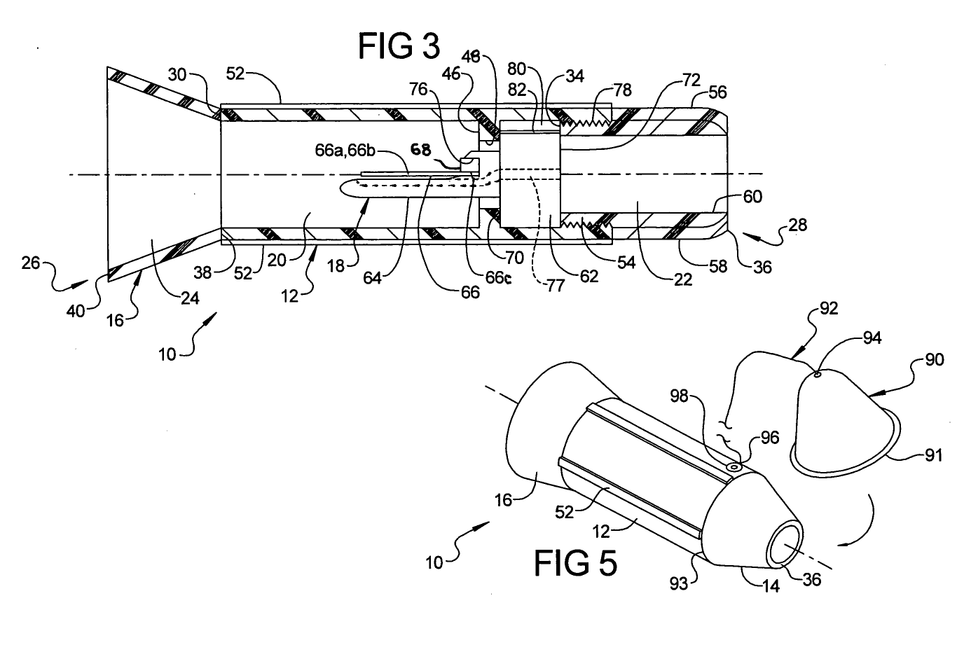

FIG. 1 illustrates the game caller and the respective elements. As shown, the horn piece 16 is separate from the sound pipe 12 and the respective end faces 30 and 38 positioned for connection to one another.

While many materials may be suitable, in one application, the horn piece 16 and strips 52 are formed of a polymeric thermoplastic sold under the trademark Santoprene®. In other applications, a suitable material is a thermoplastic elastomer.

Alternatively, in some applications, the horn piece 16 and strips 52 may be separately attached to the sound pipe. For example, a suitable adhesive may be used to connect the end face 38 of the horn piece 16 to the end face 30 of the sound pipe. Further, as desired, several longitudinal strips may be provided and adhered where desired, on and about the exterior of the sound pipe 12.

The horn piece 16 is of a flexible, pliable, elastomeric material having the properties of dimensional consistency but capable of bending, flexing, and twisting when pinched, squeezed or manipulated, whereby to change the shape or volume of the horn piece when acted upon by the external force in order to change air flow through the mouthpiece. A user-initiated change in shape of the horn piece 16 is designed to change the volume, tone, pitch, and frequency of the sound of air passing through the reed assembly 18 and the opposite ends of the game call 10.

The reed assembly 18 comprises a generally cylindrical body portion 62, a longitudinally elongated soundboard 64 extending from the body portion 62 and terminating in a convex end, a flexible reed 66, and a wedge 68 for mounting the reed to the body portion. The body portion 62 includes opposite end faces 70 and 72 and an outer periphery 74 that extends between the end faces thereof. The sounding board 64 extends from the end face 70 and is adapted to fit through the central opening 48 in the transverse end wall 46 to position the reed 66 in the sound pipe 12.

The reed 66 is thin, generally planar and, in the embodiments shown, comprises a pair of side-by-side beams or beam elements 66a and 66b that extend from a common base 66c. The beam elements are separated by a slot 66d and have deflectable tips positioned proximate to the forward convex end of the sounding board 64. The lateral width of a beam 66a and 66b is significantly greater than the lateral width of the slot 66d. The reed 66 determines the frequency of vibration and thus is related to the sound produced by blowing air through the game call 10.

The reed 66 may be fabricated from any suitable material, such as a metal, polyethylene, or composite, and have a thickness of about 0.025 inches. The reed material should be stiff yet resilient, and should be pliable and to the extent that the tip ends may be bent at a selected angle and the material will hold the bend.

A recess 76 is formed in the body portion 62 to receive the base 66c of the reed 66 and the wedge 68, the base 66c being compressed into retained relation atop the sounding board 64. Preferably, the wedge 68 is fabricated from cork or a similar material that is yieldable.

Alternatively, the reed assembly may comprise an insert injection molded receptor molded over a reed. The reed can extend into the mouthpiece or reverse for an open-ended situation. Further, the reed may be independent of the receptor and simply glued or otherwise adhered thereto.

An air passage 77 extends between the opposite ends of the reed assembly 18, generally passing through the body portion 62 from the end face 72 thereof, and opening on the sounding board 64 below the beams 66a and 66b. Further, the air passage 77 and hollow chambers of the sections 12, 14, and 16 cooperate to define a continuous air path for passing air from the mouthpiece 14, received at the inlet end of the game caller, through the reed assembly, and outwardly from the horn piece 16, at the outlet end of the game caller 10.

Structure is provided for removably connecting the mouthpiece 14 to the sound pipe 12, or mounting only a predetermined reed assembly 18 into the sound pipe, or preventing the reed assembly 18 from rotating relative to the sound pipe 12.

According to this invention, for connecting the mouthpiece 14 to the sound pipe 12, the exterior surface 58 of the mouthpiece 14 and the interior wall 44 of the chamber 50 in the sound pipe 12 are dimensioned to provide for a snug-interference fitment.

Alternatively, connection of the mouthpiece 14 to the sound pipe 12 may be complementary thread 78. Interengagement of the thread 78 and rotation of the mouthpiece 14 in a first direction causes the forward end portion 54 of the mouthpiece 14 to advance inwardly into the chamber 50 and the end face 34 of the mouthpiece to move towards and against the end face 72 of the reed assembly 18. Continued threadable advance of the mouthpiece 14 against the reed assembly drives the end face 70 of the body portion 62 thereof against the end wall 46 in the sound pipe, thereby snugly captivating the reed assembly 18 in the chamber 50 of the sound pipe 12.

Also and according to this invention, at least one axial key 80 and axial keyway 82 operate between the body portion 62 of the reed assembly 18 and the interior wall of the sound pipe 12. In assembly, the body portion 62 of the reed assembly 18 is inserted into the chamber 50 of the sound pipe, advanced, the keyway 82 thereof aligned with and slidably interfitted with the key 80 extending inwardly from the sound pipe. So fitted together, the reed assembly 18 is prevented from rotating relative to the sound pipe 12.

As shown, the slot or key way 82 is provided in the exterior surface 74 of the body portion 62 and the key 80 extends radially inward from the interior wall 44 of the chamber 50. The arrangement could be reversed.

Further, the key and key way structure may also operate to prevent the hunter from assembling a reed assembly to the game call 10 that is not optimum for the hunting experience then being pursued. In one aspect, the width of the key is greater than the width of the keyway, preventing slidable keying insertion. In another aspect, provision of at least two keyways 82 and associated keys 80, each at different angular positions, would prevent slidable keying insertion.

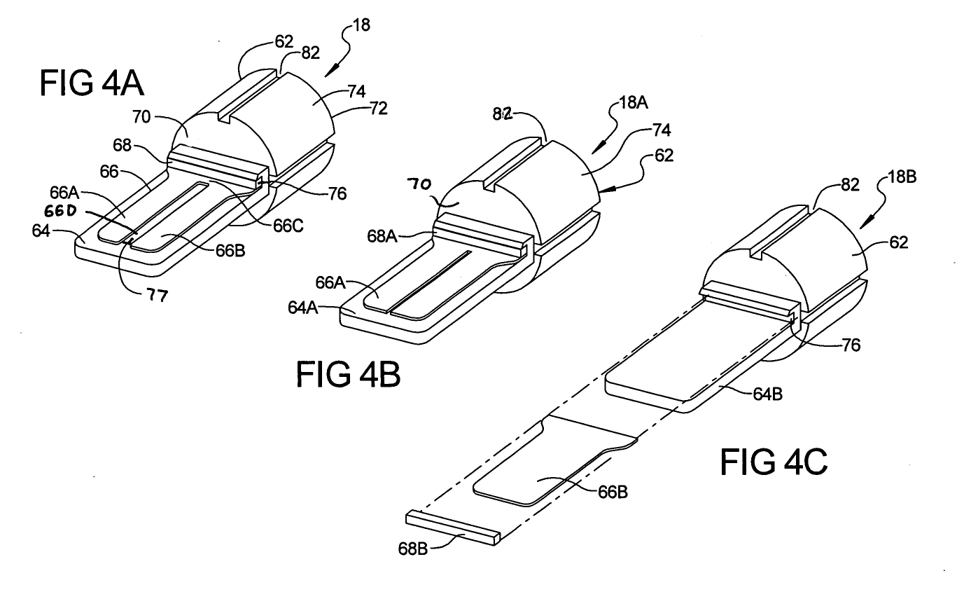

As illustrated in FIGS. 4A-4C, several different reed assemblies 18, 18A, and 18B are interchangeable with one another and adapted to be mounted into the chamber 50 of the sound pipe 12. The reed assemblies differ in the nature of the beam element(s), and thus the call or animal sound to be imitated. In FIG. 4B, the beams are narrower than the width of the beams of FIG. 4A and provide a high pitch. In FIG. 4C, the beam is a single flat plate, such as for imitating a sound to call coyotes. Further, FIG. 4C illustrates the beam element 18B and wedge element positioned for assembly into the recess 76 formed in the body portion 62.

In a desired use, according to the invention, the game caller 10 is sold in kit form. In this regard, a portable container (not shown), including a plurality of separated pockets, is provided for temporarily storing and transporting game calling items of interest, until needed. The pockets would receive items such as at least one reed body, the reed body including a body portion 62 and a sound board 64, an assembled reed assembly 18 for calling specific game and fowl, reeds 66 and wedges 68, and a tubular sound pipe 12 having the deformable bell shaped horn piece 16 of elastomeric material and a mouthpiece 14 removably connectible to the sound pipe to captivate the reed assembly 18 in the sound pipe.

In some applications, the kit may include a pair of reed bodies, each reed body including a body portion 62 and a sound board 64, and a pair of reeds 66, 66A, or 66B, each reed being mountable in cantilever fashion to a selected body portion and form a respective reed assembly 18, 18A, or 18B. According to the game caller kit, respective of the reeds, reed bodies, reed assemblies, and game caller housing are transported in separate pockets.

A caller as described herein can simulate, nearly perfectly, the call of desired game or fowl, by pinching, squeezing and manipulating (e.g., bending and/or twisting) the horn piece 16, and by selection of an appropriate reed 66. To produce the precisely desired sound, slight adjustment of the horn piece 16 is initiated by the hunter. To change the prey being hunted, the mouthpiece 14 is disconnected from the sound pipe 12 and the reed assembly 18 replaced with a different reed assembly.

Further, in some applications, the game caller 10, and the game caller kit, may be equipped with a closure cap 90. As shown in FIG. 5, a cup-shaped closure cap 90 is secured to a game caller 10 by a tether 92. The cap 90 is adapted to seat snugly in removable closing fitment about the mouthpiece 14 to protect same when the game caller is not in use, such as for prolonged periods of storage. As shown, the tether 92 has opposite ends 94 and 96, respectively, connected to the cap 90 and a support 98 on the sound pipe 12. Additionally, annular end portions 91 and 93, respectively, at the end of the closure cap 90 and around the sound pipe 12 are adapted to interlock with one another and provide a releasable snap-fit retention between the cup 90 and the mouthpiece 14.

While the preferred embodiment of the invention has been illustrated and described, it will be seen by those skilled in the art that changes and modifications may be resorted to without departing from the spirit and scope of the invention.

Having thus described the invention, what is claimed is:

1. A game caller comprising:
an assembly of three hollow tubular sections, said sections when assembled providing an air passage chamber extending between an inlet end and an outlet end of the assembly, said sections comprising a central sound pipe of rigid material and having first and second ends, a mouthpiece of rigid material, said mouthpiece including a first connectible end and said inlet end, and a horn piece of resiliently deformable material, said horn piece including a second connectible end and said outlet end,
a reed assembly mounted in the sound pipe, said reed assembly having opposite ends disposed longitudinally and an air passage extending between the opposite ends thereof for communicating air between said first and second ends,
first means for connecting said first connectible end of said mouthpiece to the first end of said sound pipe,
second means for connecting said second connectible end of said horn piece to the second end of said sound pipe,
said horn piece being adapted to change the volume, tone, pitch, and frequency of the sound of air passing through the longitudinal bore thereof and reed assembly therein by substantially simultaneously squeezing, pinching, or otherwise constricting the material thereof to close the outlet end, at least in part, and manipulating and bending and changing the shape, cross-section, and volume of the horn piece, and
means for interchanging the reed assembly with at least one other reed assembly.

2. The game caller as claimed in claim 1, wherein said mouthpiece is frusto-conical in shape and comprised of an elastomeric material.

3. The game caller as claimed in claim 2, wherein the sections and the through bore thereof are centered on a longitudinal axis, and the opposite ends of the mouthpiece are generally circular and have their centers located on the longitudinal axis, the diameter of the inlet end being greater than the diameter of the second connectible end.

4. The game caller as claimed in claim 1, wherein
each reed assembly includes a body portion having an outer periphery and a sound board extending from said body portion, and a flexible reed cantilevered to the body portion and disposed atop the soundboard,
said sound pipe includes a cylindrical interior wall and a transverse end wall, said interior wall extending between said second end and said transverse end wall and defining an enlarged chamber for receiving said body portion, and said transverse end wall defining a stop to limit inward insertion and position the reed assembly in the sound pipe, and
said first means for connecting comprises interengageable thread operating between the interior wall of the sound pipe and the first connectible end of said tailpiece, wherein said body portion is dimensioned to be snugly sandwiched between the tailpiece and the transverse end wall upon threadable connection of the tail piece to the sound pipe.

5. The game caller as claimed in claim 4, further comprising
third means for non-rotatably and removably positioning the body portion of each of said reed assemblies in the chamber formed in said sound pipe.

6. The game caller as claimed in claim 5, wherein said third means comprises a key and keyway operating between the interior wall of said sound pipe and the outer periphery of said body portion, the key being received in the keyway to angularly orient and prevent rotation of the body portion relative to the sound pipe.

7. The game caller as claimed in claim 6, wherein
a pair of keyways extend axially and radially inwardly into the outer periphery of the body portion, and
a pair of keys extend axially and radially inwardly from the interior wall of the chamber,
wherein if a proper reed assembly is selected, the keys and keyways will align and interfit with one another and the reed assembly accepted, and if not, the reed assembly will not be accepted.

8. The game caller as claimed in claim 1, wherein said means for connecting comprises the second connectible end of said mouthpiece being connected to the second end of said sound pipe by adhesive.

9. The game caller as claimed in claim 1 wherein said mouthpiece is comprised of an elastomer having the properties of dimensional consistency and capable of bending, flexing, twisting, and compressing when squeezed or manipulated to change air flow through the mouthpiece.

10. The game caller as claimed in claim 9, wherein said mouthpiece is comprised of a thermoplastic elastomer.

11. The game caller as claimed in claim 1, further comprising a removable closure cap for protectively enclosing said tail piece, and a tether for connecting said closure cap to said sound pipe.

12. The game caller as claimed in claim 1, further comprising at least one strip of a grippable polymer adhered to the exterior of the sound pipe and between the ends thereof, the strip enabling the user to grip the sound pipe during assembly and disassembly of the reed assembly and tail piece thereto.

13. A game caller kit for use by hunters, said kit comprising:
a portable container, said container having a plurality of separated pockets for temporarily storing and transporting items of interest until needed, and
a plurality of transportable items of interest, comprising:
at least a first and second reed body, each reed body including a body portion and a sound board,
at least a first and second reed, each reed being mountable in cantilever fashion to a selected body portion and form a reed assembly, and
a game caller housing, said housing comprising a tubular sound pipe having first and second ends, a deformable bell shaped mouth piece of elastomeric material connected to one of said ends, and a tail piece, the tail piece being removably connectible to the other of said ends of the sound pipe wherein to captivate a reed assembly in the sound pipe.

14. The game caller kit of claim 13, wherein respective of the reeds and reed bodies are preassembled to one another to form separate reed assemblies, each reed assembly being transported in a separate pocket.

15. The game caller kit of claim 14, further comprising a closure cap for protectively enclosing the tail piece, and a tether for attaching the closure cap to the game caller.

16. In a gamer caller of the type including a cylindrical sound pipe having inlet and outlet ends, a tail piece removably connected to the inlet end, and a reed assembly sandwiched between the sound pipe and the tail piece, the improvement wherein
an interior chamber extends inwardly from the inlet end of said sound pipe, said chamber being formed by an interior wall and a transverse stop,
said reed assembly includes a body portion having opposite end faces and an outer surface, the body portion being insertable into the interior chamber with inward insertion being limited by the stop wall engaging one end face of the body portion, and closing connection of the tail piece to the inlet end engaging the other end face of the body portion, and
a key and keyway operating between the outer periphery of the reed assembly and the interior wall of the chamber, said key and keyway having predetermined widths wherein to permit entry of only a specific reed assembly into the chamber as well as to prevent relative rotation between the reed assembly and the sound pipe.
